(19) United States
(12) Patent Application Publication
(10) Pub. No.: US 2003/0110449 A1
(43) Pub. Date: Jun. 12, 2003

(54) Method and system of editing web site

(76) Inventor: Donald P. Wolfe, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/020,003

(22) Filed: Dec. 11, 2001

(51) Int. Cl. G06F 15/00

(52) U.S. Cl. 715/522; 715/530

(57) ABSTRACT

This invention relates to methods and systems of editing a web site. In one embodiment, a web site is organized into multiple sub-sites, with each sub-site having one or more web pages. For each sub-site, a label definition file, an image definition file, and a task definition file are used to respectively store the definitions of the labels, images, and tasks of the web pages of the sub-site. The label definition file and the image definition file are advantageously XML files. A label, image, or task that is shared by multiple web pages of a sub-site can be edited from one web page of the sub-site. When the other web pages are requested for display, they are generated to reflect the change of the shared label, image, or task.

### BACKGROUND

1. Field of the Invention

This invention relates to the field of web site programming.

2. Description of the Related Art

Web sites are typically programmed using markup languages such as HTML, (Hyper-Text Markup Language) WML, (Wireless Markup Language) and XML (eXtensible Markup Language). In order to edit a web site, for example to add, change or remove certain labels, images or functions from some web pages of the web site, the underlying HTML, WML, OR XML program files typically need to edited.

Since a web site may include a large number of pages and a large number of labels, images and/or functions to be edited, such editing may require editing a large number of program files. Editing a large number of program files is not only labor intensive, but also skill intensive, because it requires editing the program files. The program files need to be edited even when most of the editing does not concern the basic functionality of the web site.

For example, when a U.S. web site expands into international markets, the functionality of the U.S. web site is inherited to a large extent, in order to maintain the same look and the same business properties of the web site. Copies of the U.S. web site need to be edited so that the text labels and images are displayed in the language of the local market. Such a localization project may also require editing certain functions (also called tasks) of the web site, in order to reflect the local business practice that is different from the U.S. practice. For example, a task that builds a list of models offered in U.S. markets by a car company may have to be customized to build a different list of models offered in a foreign market by the same car company. Even if most of the editing only involves editing labels and images, the underlying program files still need to be edited, therefore requiring much labor and skill.

### SUMMARY

The present application discloses improved methods and systems of editing a web site. One aspect of the invention relates to a system for editing a web site having a plurality of web pages, the system including:

A task editing module configured for, creating modifying and removing a plurality of tasks that may be invoked by the web site, each of the plurality of tasks including a task identifier and a task function, the plurality of tasks being stored in one or more task definition files;

A label editing module configured for creating, modifying and removing a plurality of labels that may be displayed on one or more of the plurality of web pages of the web site, each of the plurality of labels including a label identifier and a label text, the plurality of labels being stored in one or more label definition files;

An image editing module configured for creating, modifying and removing a plurality of images that may be displayed on one or more of the plurality of web pages of the web site, each of the plurality of images including an image identifier and an image file name, the plurality of images being stored in one or more image definition files; and

A page generating module configured for generating each of the plurality of web pages of the web site, the page generating module being configured to obtain a display format of a web page from a style sheet file, the style sheet file including label identifiers of the labels to be displayed on the web page and image identifiers of the images to be displayed on the web page, the page generating module being further configured to obtain from label definition files the label texts of the labels to be displayed on the page, the page generating module being further configured to obtain from image definition files the image file names of the images to be displayed on the page, the page generating module being further configured to obtain from task definition files the task functions of the tasks to be invoked to build the page.

Another aspect of the invention relates to a method of modifying a web site having a plurality of web pages, the method including:

Storing label definitions in one or more label definition files in a markup language format, each of the label definitions including a label identifier and a label text;

Storing task definitions in one or more task definition files, each of the task definitions including a task identifier and a task function;

Storing image definitions in one or more image definition files in a markup language format, each of the image definitions including an image identifier and an image file name;

For each of the plurality of web pages, identifying one or more (if any) labels to be displayed on the web page by referring to the label identifiers of the labels, identifying one or more (if any) images to be displayed on the web page by referring to the image identifiers of the images, and identifying one or more (if any) tasks to be invoked on the web page by referring to the task identifiers of the tasks;

Prompting a user to modify a stored definition of a label, a task, or an image; and

For each of the plurality of web pages, generating the web page upon receiving a generation request, according to the identified labels, images, and tasks.

### BRIEF DESCRIPTION OF THE DRAWINGS

Certain embodiments of the invention are best described in connection with the following drawings.

FIG. 1 is a diagram that illustrates users interacting with web sites.

FIG. 2 is a diagram that illustrates one embodiment of generating web pages of a web site.

FIG. 3 is a sample driver file for generating web pages.

FIG. 4 is a diagram that illustrates a web site editing system.

FIG. 5 is a diagram that illustrates a structure definition in XML of a sample web site.

FIG. 6 is a sample master XML file.

FIG. 7 is a sample task function definition file.

FIG. 8 is a sample label definition file.

FIG. 9 is another sample label definition file.

FIG. 10 is a sample image definition file.

FIG. 11 is another sample image definition file.

FIG. 12 is a sample starting page of a web editing process.

FIG. 13 is a sample web page for editing a sub-site.

FIG. 14 is a sample default XSL file.

FIG. 15 is a sample XSL file.

FIG. 16 is a sample web page for editing another web page.

FIG. 17 is another sample web page for editing another web page.

### DETAILED DESCRIPTION OF THE PREFERRED EMBODIMENT

One embodiment of the invention is described below, which is advantageously implemented in the XML language in conjunction with XSL (eXtensible Style Language).

Overview of Communication Architecture

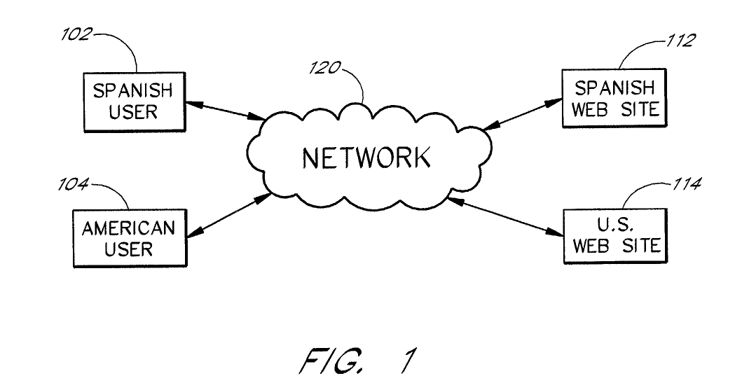

FIG. 1 is a diagram that illustrates users interacting with web sites. From a client device such as a personal computer, a cell phone or a pager, a Spanish user 102 accesses a Spanish web site 112 via the a network 120 such as the Internet or an Intranet. A U.S. user 104 accesses a U.S. web site 114 via the network 120. The web sites 112 and 114 are advantageously output as XML pages to the users 102 and 104 through web browsers. The web sites 112 and 114 may also be output in other formats such as HTML and WML to the user. In one embodiment, the Spanish web site 112 is a customized copy of the U.S. web site 114. For example, after the U.S. web site 114 is established, the commercial entity that owns the U.S. web site 114 expands into Spain and the Spanish web site 112 is created. The Spanish web site 112 maintains the general look and functionality of the U.S. web site 114, but includes customizations such as displaying text and logos in Spanish and modifying some web pages of the web site 112 to reflect Spanish business practices that are different from the U.S. practices. Improved methods and systems are described in the present application that facilitate the creation and modification of web sites such as the Spanish web site 112. The phrase “the web site 112” will be used below to refer to a first-established web site such as the U.S. web site 114, a later customized web site such as the Spanish web site 112, and other customized web sites.

In another embodiment, the U.S. user 104 and the Spanish user 102 access the same starting point web site. The users then access country specific web pages within the web site.

Overview of Using XML to Generate Web Pages

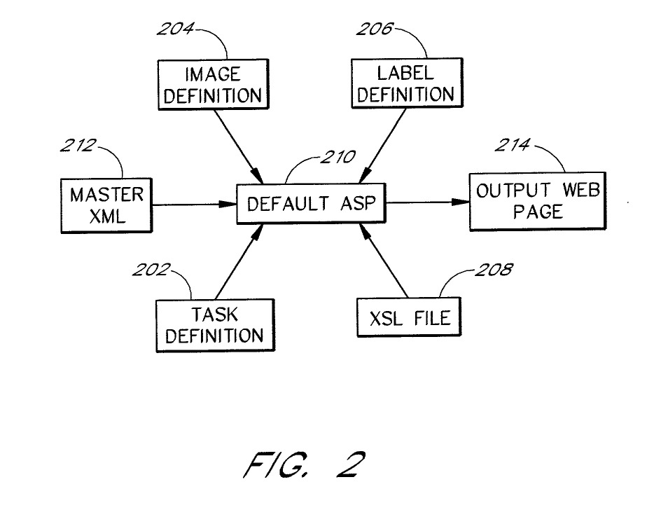

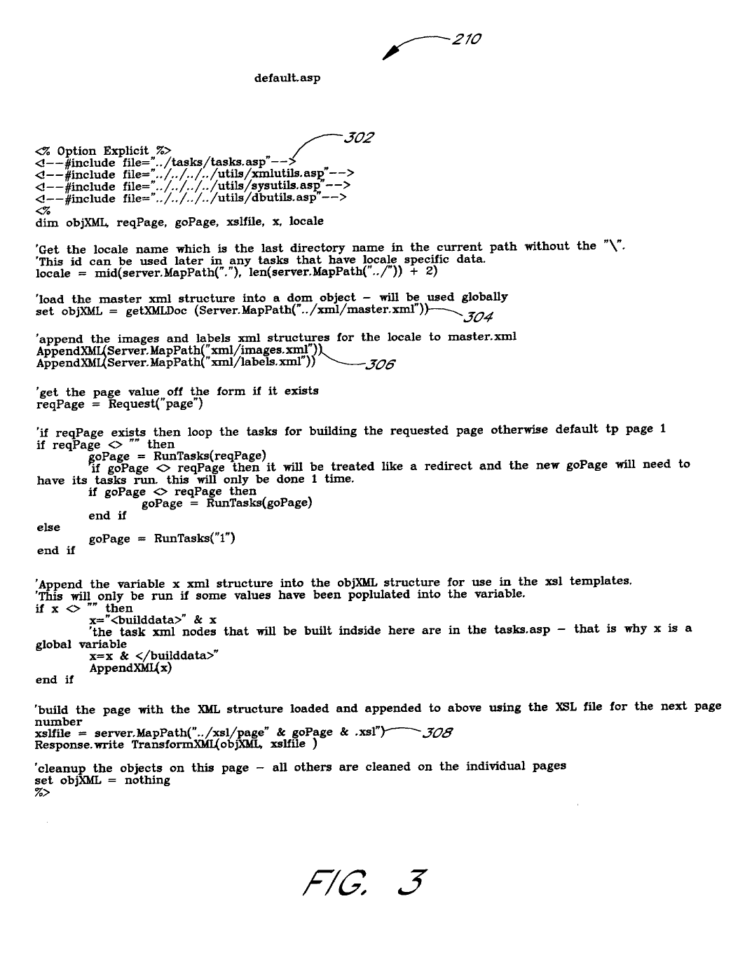

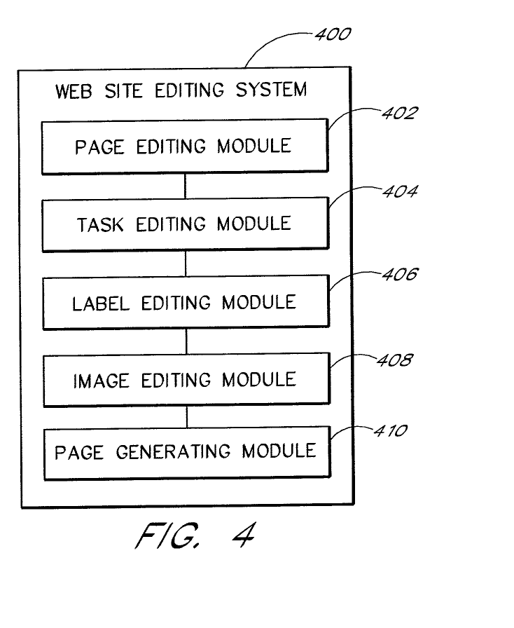

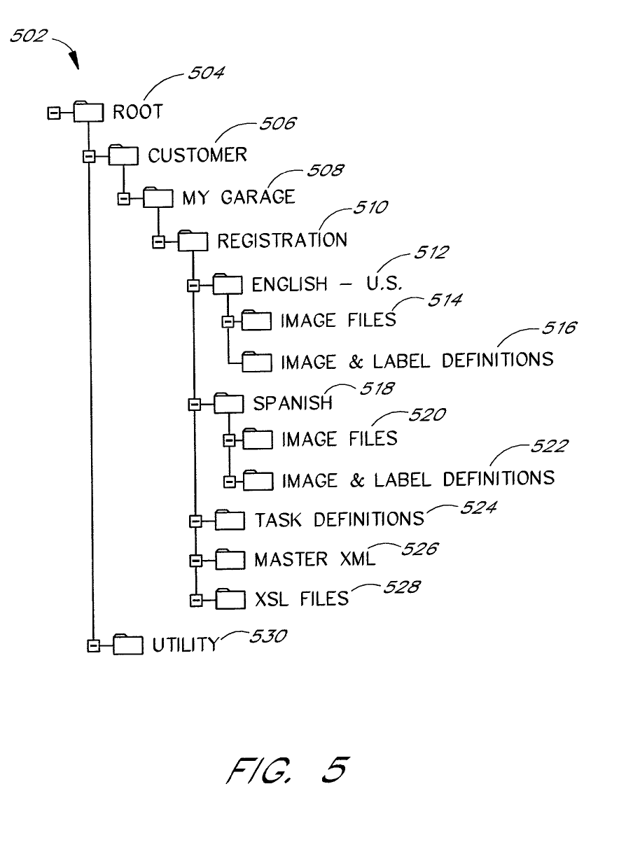

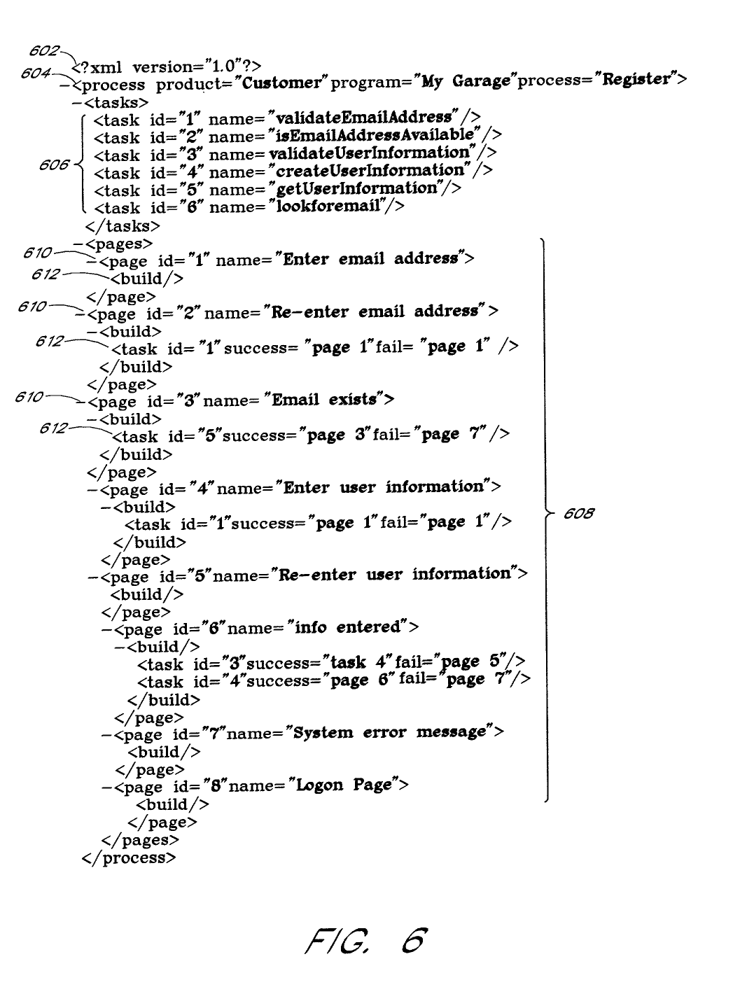

FIG. 2 is a diagram that illustrates one embodiment of generating a web page of a web site 112. Each web page of the web site 112 is associated with a task definition file 202, an image definition file 204, a label definition file 206, and an XSL file 208 that defines the display format of the web page. An XSL (eXtensible Style Language) file is a file that defines the display format of a XML file, such as the location of text and graphics displays on a web page, the font of letters on the web page, and so forth. As described below in connection with FIG. 5, multiple web pages can share the same task definition file 202, label definition file 206, and image definition file 204. Multiple web pages also share a master XML file 212 that defines a group of web pages, including the tasks of each page within the group and the success or fail consequence of each task. More details regarding the master XML file 212 are described below in connection with FIG. 6.

Referring to FIG. 2, multiple web pages can also share the same driver file such as a default ASP (Active Server Page) file 210.

Upon receiving a request for a web page, the content of the labels and images of the web page are obtained respectively from the label definition file 206 and the image definition file 204. The program code that executes the tasks of the web page can be obtained from the task definition file 202. The definition of the web page, including tasks of the web page and the success or fail consequence of each task, is obtained from the master XML file 212. The display format of the web page is obtained from the XSL file 208. The default ASP file 210 then generates the output web page 214.

In one embodiment, the output web page 214 is displayed in XML format. In another embodiment, the output web page 214 is displayed in HTML or WML format. Displaying in a non-XML format may be desirable when a portion of users do not have XML-enabled web browsers. In one embodiment, the output web page 214 is immediately sent to the client computer after receiving the request. In another embodiment, the output web page 214 is cached at a storage place connected to the server computer.

FIG. 3 is a sample default ASP file 210 for generating web pages. In the embodiment illustrated by the sample default ASP file 210, each web page of the web site 112 is associated with a task definition file task.asp, a label definition file labels.xml, an image definition file images.xml, and an XSL file. Referring to FIG. 3, section 302 obtains the task definition file “task.asp” for the web site. Section 304 obtains the master XML file “master.xml” for the web site. Section 306 obtains the image definition file “images.xml” and the label definition file “labels.xml” for the web site. Section 308 obtains the XSL file of the web page. The web page is then generated by the default ASP file, using the display format defined in the XSL file, the content definitions of the task, image and label definition files, and the definitions of the master XML file.

Overview of Web Site Editing System

FIG. 4 is a diagram that illustrates a web site editing system 400. The web site editing system 400 includes a page editing module 402, a task editing module 404, a label editing module 406, an image editing module 408, and a page generating module 410. A module includes a series of computer instructions embodied in software, hardware, firmware, or any combinations of the above. Modules can be combined or separated into more or fewer modules. In one embodiment, the web site editing system 400 also includes a sub-site editing module (not shown) for editing a sub-site. Sub-sites are described below in connection with FIG. 5.

The page editing module 402 is configured for adding to and removing web pages from the web site or a sub-site of the web site. The page editing module 402 also allows a user to edit tasks, labels, and images of a web page by accessing the task editing module 404, the label editing module 406, and the image editing module 408 respectively.

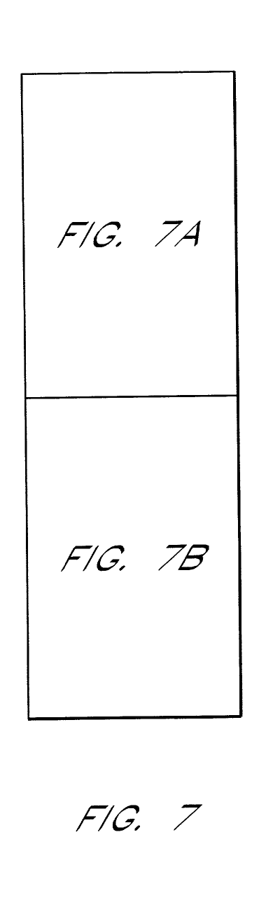

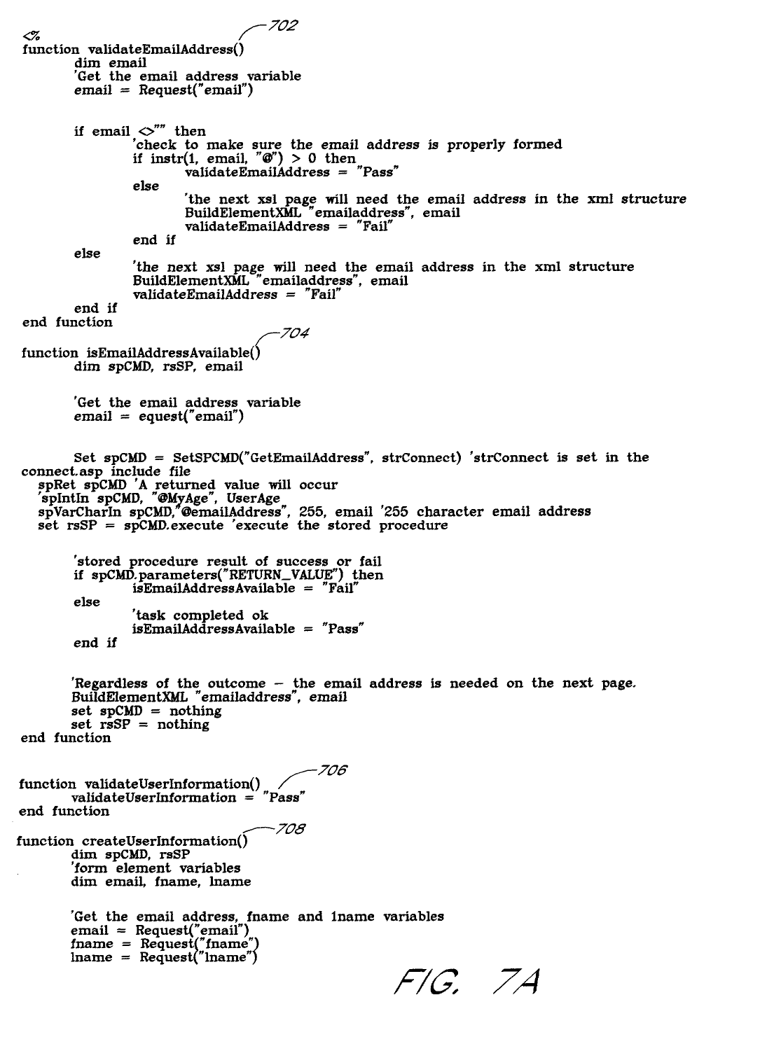

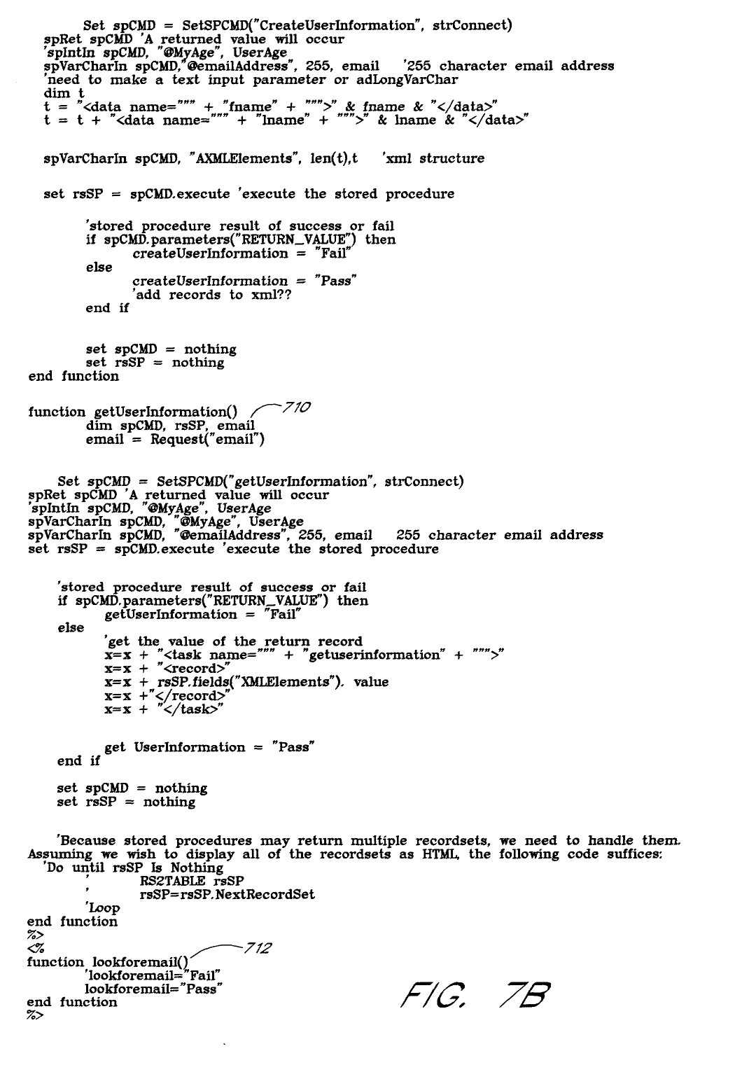

The task editing module 404 is configured for creating, modifying and removing tasks that may be invoked by the web site 112. In one embodiment, the task editing module 404 is configured for editing a success task or page and a fail task or page of a task. The success task or page and fail task or page of each task is stored in the master XML file. More details of the success task or page and the fail task or page are described in connection with FIG. 6. Each task includes a task identifier and a task function. The task identifier identifies the task, the task function defines the program code to perform the task. In one embodiment described in connection with FIG. 7, each task also includes a task name to better identify the task, the task names and task functions are stored in one or more task definition files. The label editing module 406 is configured for creating, modifying and removing labels that may be displayed by the web site 112. Each label includes a label identifier and a label text. The label identifier identifies the label, the label text defines the text to be displayed on web page(s) for the label. The definition of labels are stored in one or more label definition files. The image editing module 408 is configured for creating, modifying and removing images that may be displayed by the web site 112. Each image includes an image identifier and an image file name. The image identifier identifies the image, the image file name identifies the graphics file or application to be displayed or executed on web page(s) for the image. The definitions of images are stored in one or more image definition files.

The page generating module 410 is configured for generating web pages of the web site 112. Using the page generating module 410, a web page is generated by running a driver file, obtaining label definitions from a label definition file, obtaining image definitions from an image definition file, obtaining task execution codes from a task definition file, obtaining a definition of web pages from a master XML file, and obtaining display format information from a style sheet file.

XML Structure Definitions

FIG. 5 is a diagram that illustrates a structure definition in XML of a sample web site. A hierarchical structure tree 502 displays the structure of the sample web site. From a root level 504 (the highest level), the structure tree 502 proceeds to lower levels of member levels (506 and 530) and sub-members levels (508, 510, etc.), until the lowest structure level, the web page level (not shown), is reached. In one embodiment illustrated in FIG. 5, several intermediate levels are defined between the root level 504 and the page level, including the product level, the program level, and the process level. The product level is the level immediately below the root level 504, it includes the “Customer” element 506 and the “Utility” element 530. The program level is the level immediately below the product level, it includes the “My Garage” element 508. The process level is the level immediately below the program level, it includes the “Registration” element 510. A web site can be defined with more or fewer intermediate levels. A web site can also be defined with a root level, a page level, and no intermediate levels.

In the embodiment shown in FIG. 5, country specific elements “English-U.S.” 514 and “Spanish” 518 are defined below the process level, forming the country level. The elements 514 and 518 are defined at a country level below the process level but above the page level. The “Image Files” elements 514 and 520 respectively identify the image files that may be displayed on the U.S. and Spanish web pages, for example, “us_logo.jpg” and “esp_logo.jpg”. The “Image & Label Definitions” elements 516 and 522 respectively identify the file or files that store the U.S. and Spanish image and label definitions, for example, images.xml and labels.xml for each country. In other embodiments, the country specific elements can be defined at the root level, the page level, or another intermediate level. For example, the country level can be located between the process level and the program level, or between the program level and the product level.

Referring to FIG. 5, at the process level that is not country specific, the “Task Definitions” element 524 identifies the file that stores the definitions of the tasks for the “Registration” process, for example, the task.asp file. The task functions are defined at the process level, because most of the functions are not country specific. The tasks can also be defined at the country level if a large number of tasks are country specific. The “Master XML” element 526 identifies the file that stores the definition of the “Registration” process, for example, the master XML file. The “XSL Files” element 528 identifies the XSL files, with each XSL file corresponding to a web page of the “Registration” process.

Defining images, labels, and tasks at higher than page level allows some degree of abstraction. After an image, a label, or a task is edited on one web page, other pages that share the edited image, label, or task can be generated to reflect the change, without the need to duplicate the editing on each page. On the other hand, if images, labels, and tasks are all defined at the root level, they may become too numerous and too complex to manage. Since a large web site may include hundreds of web pages and thousands of labels, images, and tasks, managing all the definitions at the root level may be too complex. For example, all the potentially thousands of labels must be assigned unique identifiers. For another example, if a label is modified, all pages of the web site may have to be analyzed for potential update and/or re-generated. In yet another example, if a label is modified erroneously at one place, then a large number of pages of the web site may contain the same error. Therefore, it is often desirable to define images, labels, and tasks at an intermediate level below the root level but above the page level.

Master XML File

FIG. 6 is a sample master XML file 602, which is identified by element 526 of FIG. 5. Referring to FIG. 6, the master XML file 602 includes the definition of a process. A process typically includes multiple web pages of the web site. For example, the portion of the web site 112 that relates to customer registration for the “My Garage” program is called a process. The process header section 604 identifies the product, program, and process of the master XML file 602. The task list section 606 lists tasks that are invoked or may be invoked by the identified process. For each task, a task id and a task name are listed in the section. Dormant tasks, i.e. tasks that are not currently invoked by any web pages of the process, can also be included to be invoked in the future. In another embodiment in which a task includes a task identifier and a task function but not a task name, no task name is listed.

A task is a function performed on a web page, such as retrieving data, performing a business rule, performing a security check, and so forth. In the embodiment shown in FIG. 6, tasks are defined at the process level, so that tasks for the same process can be shared by web pages for the process. It should be understood that tasks can also be defined at higher or lower levels of the structure tree 502. For example, tasks can be defined at the root level, so that all tasks for the web site can be shared by all web pages of the site.

Still referring to FIG. 6, a page section 608 lists web pages that are displayed or may be displayed by the process. Each web page has a page header node 610 and a build node 612. The page header node 610 lists the page id and page name of the web page. The build node 612 lists tasks that are invoked by the web page. A build node 612 can be empty, such as the build node for web page of page id 7 and page name “System Error Message.” In addition to listing the corresponding task ids for the tasks invoked by the web page, a build node 612 also lists a success task or page and a fail task or page associated with every task id. The success task or page identifies the task to be invoked or the page to be displayed if the task identified by the task id is successfully executed. The fail task or page identifies the task to be invoked or the page to be displayed if the task identified by the task id is executed unsuccessfully. For example, referring to the page header node 610 with page id 3 and page name “Email exists”, if task of id task 5 and name “getUserInformation” is executed successfully, then the page of page id 3 and name “email Exists” is displayed. If the task is executed unsuccessfully, then the web page of page id 7 and name “System error message” is displayed.

Task Function File

FIG. 7 is a sample task function file that defines task functions for a process. In one embodiment illustrated in FIG. 7, the task function file is a .asp (Active Server Page) file. The task with the task name “validateEmailAddress” 702 in the .asp file corresponds to the same task “validateEmailAddress” in section 606 of FIG. 6. The task definition file of FIG. 7 also includes the definition of tasks “isEmailAddressAvailable” 704, “validateUserInformation” 706, “createUserInformation” 708, “getUserInformation” 710, and “lookforemail” 712. In another embodiment, the task function file can be a JSP (Java Server Page) file. The task function file can also use other scripting languages such as Cold Fusion, Javascript, Pearl, and so forth.

Label Definition File

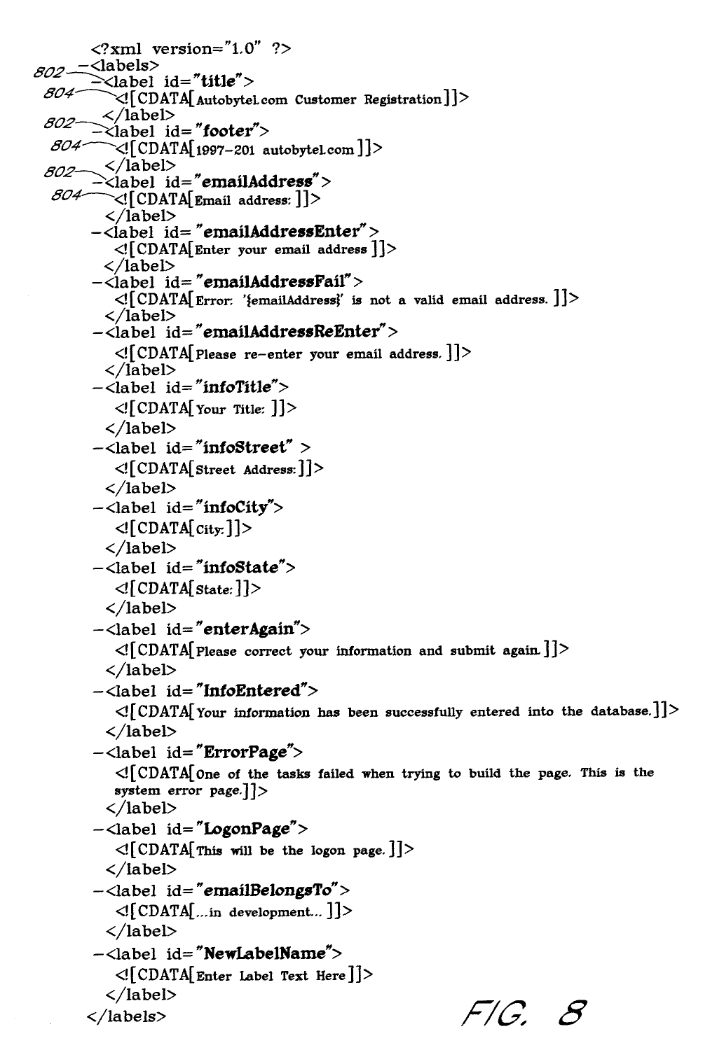

FIG. 8 illustrates a sample label definition file, which stores the label identifier and the label text of each label of the country. In the embodiment shown in FIG. 8, and referring back to FIG. 5, the labels are defined as country specific below the process level. Therefore label texts for labels defined in the label definition file for a given country can be shared among web pages of the same process for that country, and labels with the same label id for different countries can have different label text. Labels can also be defined at a higher or lower level, such as the root level or the page level. Dormant labels, i.e. labels not currently displayed on any web page of the country, can also be included in the label definition file.

Still referring to FIG. 8, the label definition file lists all labels that may be displayed by one or more U.S. web pages of the “Customer-My Garage-Registration” process. Each label includes a label id 802 and a label text 804. In one embodiment, HTML codes such as “<br>” and “</br>”, “<b>” and “</b>”, “<u>” and “</u>”, and so forth, can be embedded into the label text 804 as directions to display a line break, to display in bold type, to display in underline, and so forth. The sample label file shown in FIG. 8 illustrates a label file for the country United States, with the label text displayed in English.

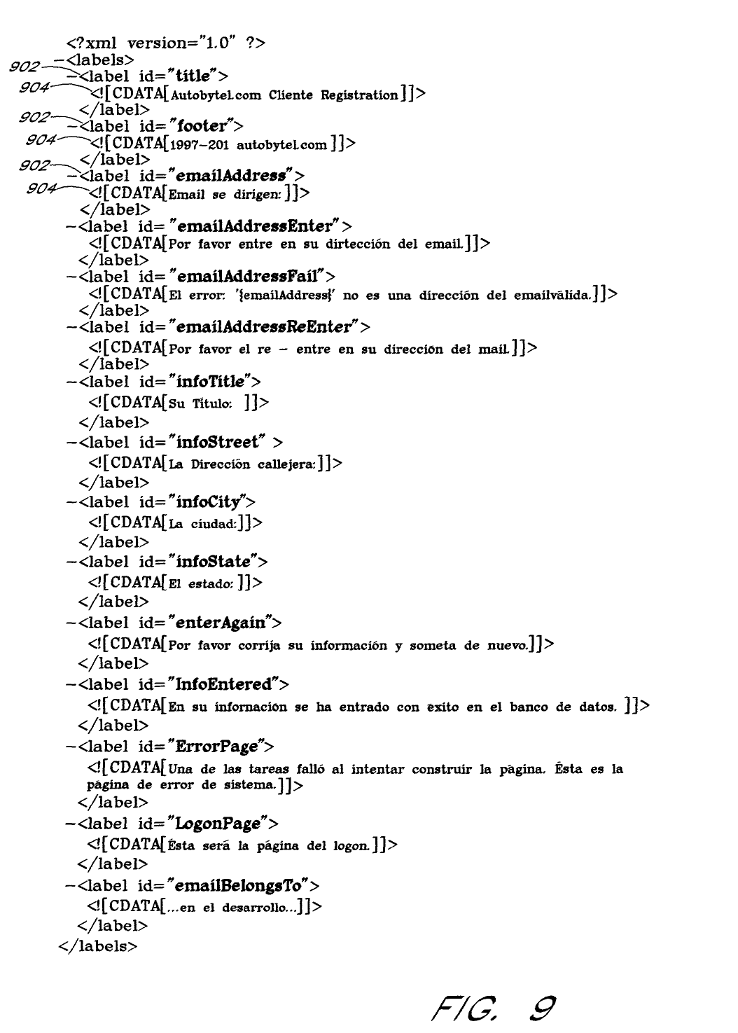

FIG. 9 illustrates another sample label definition file. The label file in FIG. 9 is for the country Spain, with the label text displayed in Spanish. In FIG. 9, the label definition file lists all labels that may be displayed by one or more Spanish web pages of the “Customer-My Garage-Registration” process. Each label includes a label id 902 and a label text 904. The labels in FIG. 8 and FIG. 9 share the same label ids but different label text, one in English and another in Spanish.

Image Definition File

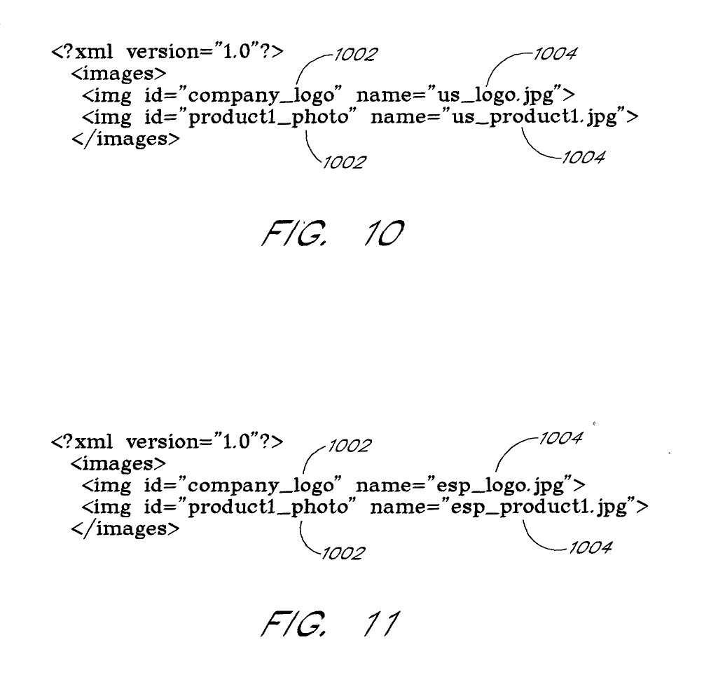

FIG. 10 illustrates a sample image definition file. FIG. 10 lists all images that are displayed or may be displayed in the U.S. web pages for the “Customer-My Garage-Registration-U.S.” country level. Each image definition listed in FIG. 10 includes an image id 1002 and an image file name 1004, which identifies the corresponding image file. An image file can be a JPEG file, a GIF file, an animation application such as Flash or Shockwave from MacroMedia, and so forth. In the embodiment shown in FIG. 10, and referring back to FIG. 5, the images are defined as country specific and below the process level. Therefore images files for images for a given country can be shared among web pages of the same process for that country, and images with the same image id for different countries can have different image file names and therefore different image graphics. For example, two images with the same image id “company_logo” can have different image file names, one image for the country United States corresponding to a “us_logo.jpg” image file, and the other image for the country Spain corresponding to a “esp_logo.jpg” image file. Making images country-specific may be desirable, because images often include letters and characters that are language-specific, and because some images are culturally sensitive. Images can also be defined at a higher or lower level, such as the root level or the page level. For example, if most of the images are shared by different countries, then images can be advantageously defined at a level that is higher than the country level in the hierarchical structure. Images at a level above the country level are therefore not country-specific. Dormant images, i.e. images not currently displayed on any web page of the country, can also be included in the image definition file.

FIG. 11 illustrates another sample image definition file. The image file in FIG. 11 is for the country Spain, with the image file names corresponding to Spanish image files. The images in FIG. 10 and FIG. 11 share the same image ids but different image files, one in English and another in Spanish.

As shown in FIGS. 8-11, the definitions for labels and images are stored in XML files in one embodiment. The process is also defined in a master XML file as shown in FIG. 6. The user interfaces for editing sub-sites and web pages are also programmed in a markup language such as XML, and displayed as web pages themselves. Storing definitions in XML files and editing definitions using a web page user interface have several advantages. For example, a user need not learn another user interface such as a relational database interface or an object oriented database interface for editing the labels, images, tasks, pages, processes, and other elements. The elements can be easily managed using a web browser on a web page. In addition, no additional data management system is needed for storing and managing the definitions. Using XML files for storing elements that define a web site is also consistent with the XML, HTML, or XML format of the web site itself.

Web Editing Administration Tool

A web editing administration tool is used to add, change and remove labels, images, and tasks of the web site 112. In one embodiment, the web editing tool is advantageously written in XML and permits interaction with a user via a web browser and a collection of web pages. The web editing tool is defined in one embodiment as a web editing process of the web site 112. The functions such as adding a label to a page, removing a task from a page, updating an image on a page, listing the web pages of the web site, and so forth, are managed as tasks themselves. Using such an embodiment, the user can manage the web editing tool in the same manner he/she manages the web site, without the need to learn another user interface of the web editing tool. Such an embodiment also ensures that the web editing tool itself can be easily edited. Some sample pages of the web editing process are described below.

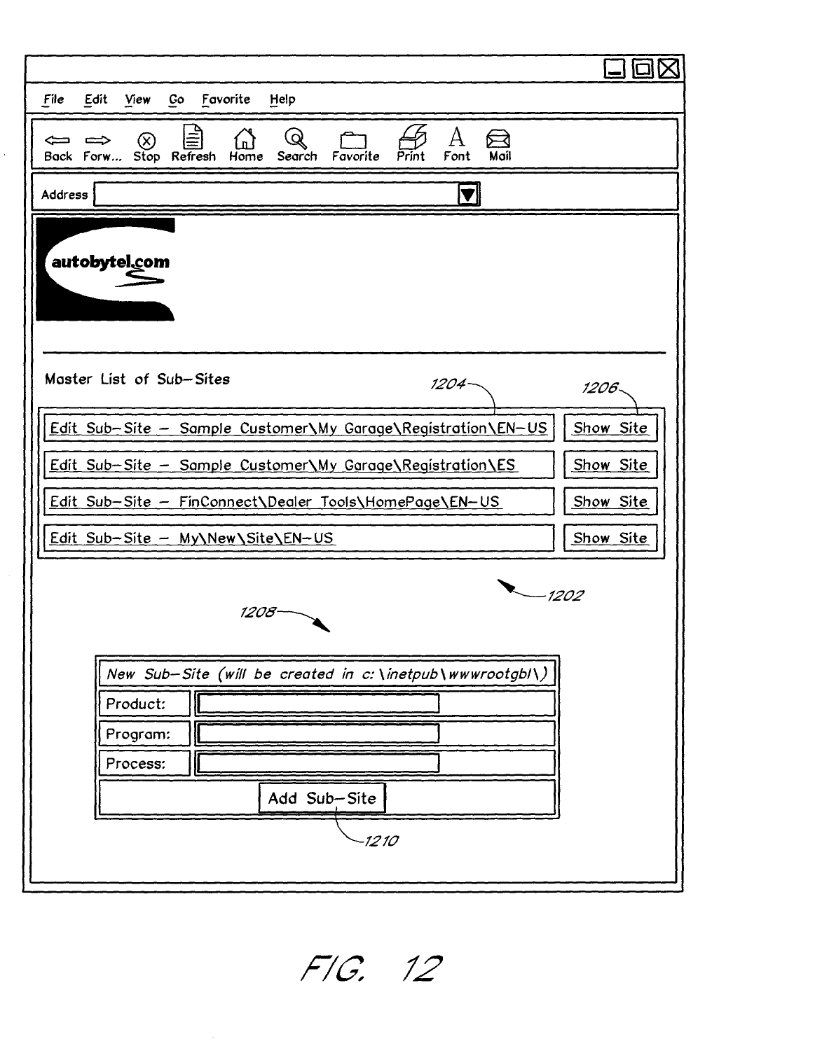

FIG. 12 is a sample starting page of the web editing process. A list of sub-sites of the web site 112 are displayed in section 1202 of FIG. 12. Since the country level is defined below the process level, as shown in FIG. 5, each sub-site is defined by a product, a program, a process, and a country. Referring back to FIG. 12, column 1204 of section 1202 displays the product name, program name, process name, and country name of each sub-site, separated by the symbol “\”. For example, FIG. 12 lists one sub-site with a product name of “Sample Customer”, a program name of “My Garage”, a process name of “Registration”, and a country name of “EN-US” (English-United States). By clicking on a “Edit Site” hyperlink in column 1204, a user navigates to a site editing page illustrated by FIG. 13. By clicking on a “Show Site” hyperlink in column 1206 of the section 1202, a user navigates to the starting web page of the sub-site.

Section 1208 allows a user to add a new process by entering a product name, a program name, a process name and then clicking the “Add Sub-Site” button. After the “Add Sub-Site” button is activated, a plurality of sub-sites are created by the web editing tool. Each of the plurality of sub-sites has the entered product name, program name, and process name. Each of the plurality of sub-sites corresponds to a different country defined at the country level. A default master XML file and a default task definition file are created for the new process. A default image definition file and a default label definition file are created for each sub-site.

In another embodiment, only a U.S. sub-site is created for the process. A user then selects an additional “Add Country” or “Add Language” option (not shown on FIG. 12) to add a new sub-site similar to the U.S. sub-site. The additional “Add Country” or “Add Language” option prompts the user to enter a product name, program name, process name, and country name. A new sub-site corresponding to the entered product, program, process and country name is then created.

After sub-sites are added, section 1202 is refreshed to display the newly added sub-sites in the list of sub-sites. A user can also add a product or a program to the web site 112, by entering a new product name or a new program name in the section 1208.

Editing a Sub-Site

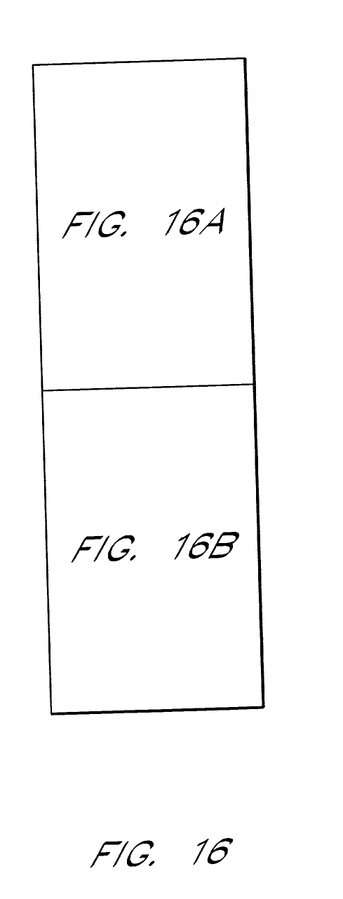

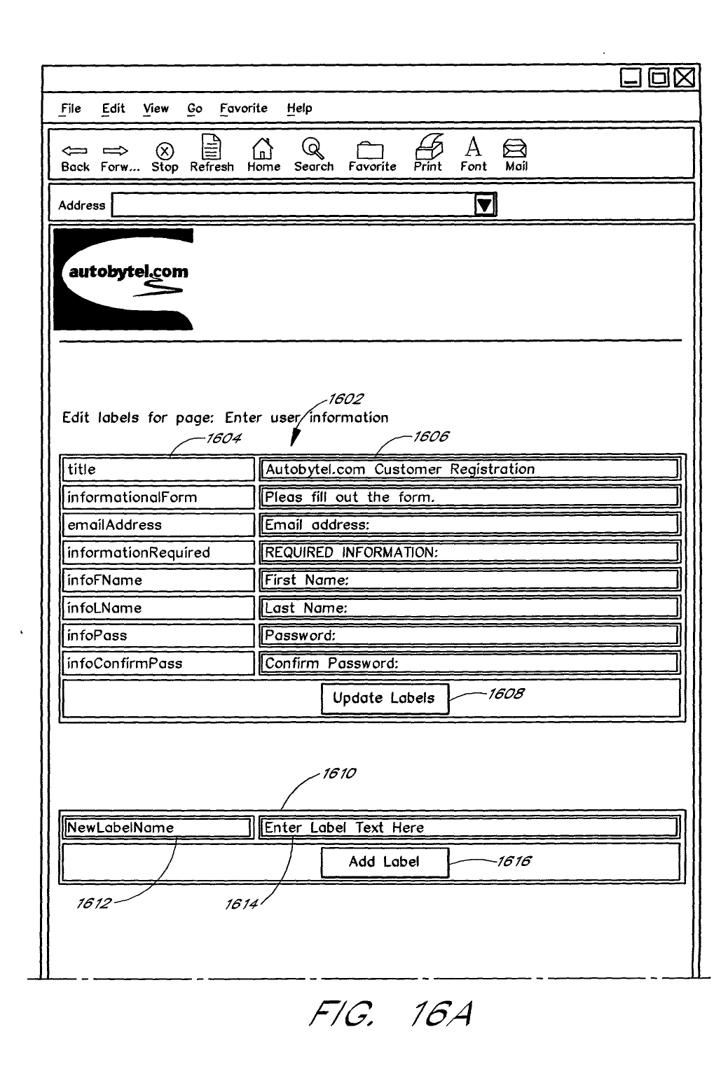

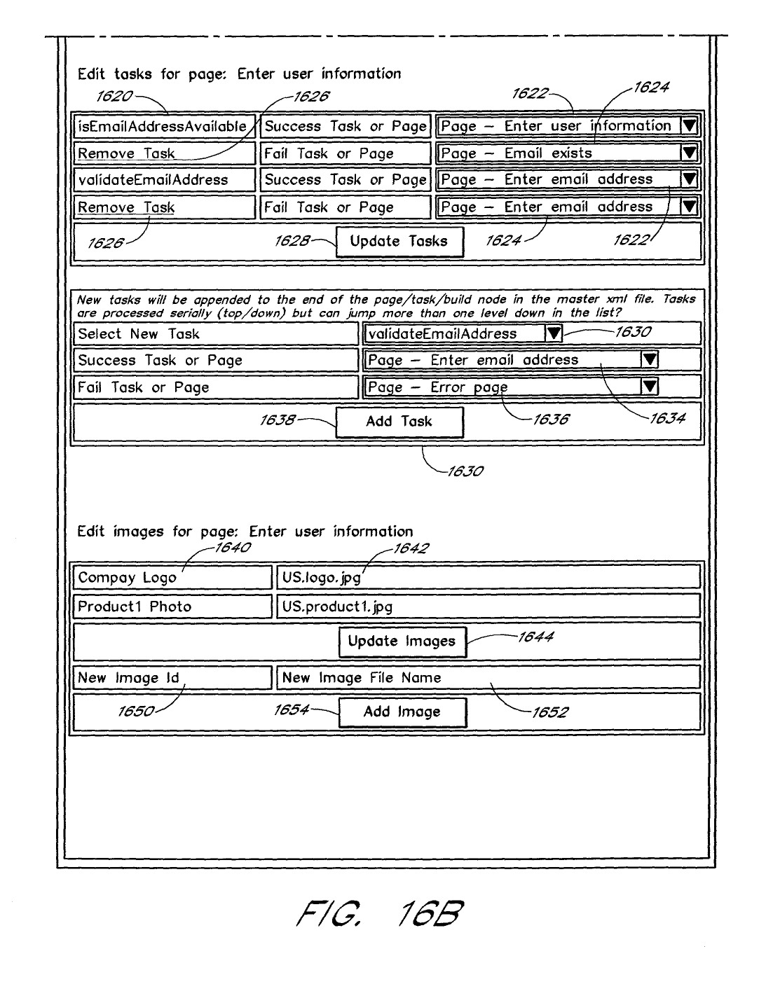

FIG. 13 is a sample web page for editing a sub-site. Section 1302 lists all web pages of the sub-site. Column 1304 lists the page name of listed web pages. column 1306 contains a “Edit Source” hyperlink. By clicking on a “Edit Page” hyperlink in column 1304, a user navigates to a page editing page illustrated by FIG. 16. By clicking on a “Edit Source” hyperlink in column 1306, a user navigates to a XSL file editing space to edit the XSL file associated with the listed web page.

Section 1308 allows a user to add a new page to the sub-site by entering a new page name and clicking the “Add Page” button 1308. A new page identifier is created for the new page. The section 1302 is refreshed to include the added page in the list of web pages of the sub-site. The newly added page with its page identifier and page name are added to the page section 608 of the master XML file of the sub-site. A default XSL file is automatically created for the added page. A sample default XSL file is illustrated in Appendix A, which is incorporated by reference in its entirety.

In another embodiment, a user is prompted to select a default XSL file from a plurality of default XSL files, with each XSL file representing a custom template of a web page. Each template represents a commonly used web page layout.

Referring back to FIG. 13, to identify the parent page of the added page, i.e., the page where the added page navigates from, the user activates the “Edit Source” hyperlink of the parent page, and adds the page identifier of the added page of the XSL file of the parent page.

Referring to FIG. 13, section 1310 lists all tasks of the sub-site. Column 1312 lists the task name of every listed task. In one embodiment, the column 1312 lists the task identifiers of listed tasks. By clicking on a “Edit Source” hyperlink in column 1314, a user navigates to an editing space for editing the corresponding task function file. One example of a task function file is illustrated in FIG. 7.

Referring back to FIG. 13, field 1316 and field 1318 allow a user to add a new task to the process of the sub-site by entering a new task name in field 1316 and clicking the “Add Task” button of field 1318. A new task identifier and a default task function file are automatically assigned to the added task. The newly added task with its task identifier and task name is added to task list section 606 of the master XML file of the process of the sub-site. The section 1310 is refreshed to include the added task in the list of tasks. In one embodiment, field 1316 displays a scroll down list of task names or task identifiers for tasks that are defined in other processes of the web site 112. After a user selects a task from the scroll down list and clicks the “Add Task” button 1318, the selected task is added as a task of the process of the current sub-site.

In another embodiment, FIG. 13 also lists all images of the sub-site. For each image of the sub-site, its image id is listed in a first column and its image file name is listed in a second column. A user can change the image file name of a image by typing in the second column. After the user completes typing the changed image file name, the user clicks a “Update Images” button to order the web editing tool to update the image definitions. The web editing tool then updates the image definitions in the image definition file.

In another embodiment, FIG. 13 allows a user to add a new image definition by entering an image identifier and a image file name. In one implementation, the user is prompted to select an image file name from a scroll down list of available image files. After the image identifier and the image file name are entered, the user clicks a “Add Image” button to order a creation of the new image definition. The web editing tool then adds the newly created image definition to the image definition file. In another embodiment, the user adds a new image to the current sub-site by selecting from a scroll down list of image identifiers of other sub-sites of the web site 112.

In yet another embodiment, FIG. 13 also lists all labels of the sub-site and allows a user to modify or to add labels to the sub-site, using procedures similar to the above described procedures of listing, modifying, and adding images. In addition to from the sub-site level, tasks, labels, and images can also be listed, added, updated and removed from the process level, the program level, the product level, or the root level. In one embodiment described below, tasks, labels, and images are listed and edited from the page level. This embodiment facilitates the user's understanding of the tasks, labels and images being listed and edited, because the user typically associates the elements with particular web pages.

XSL FILES

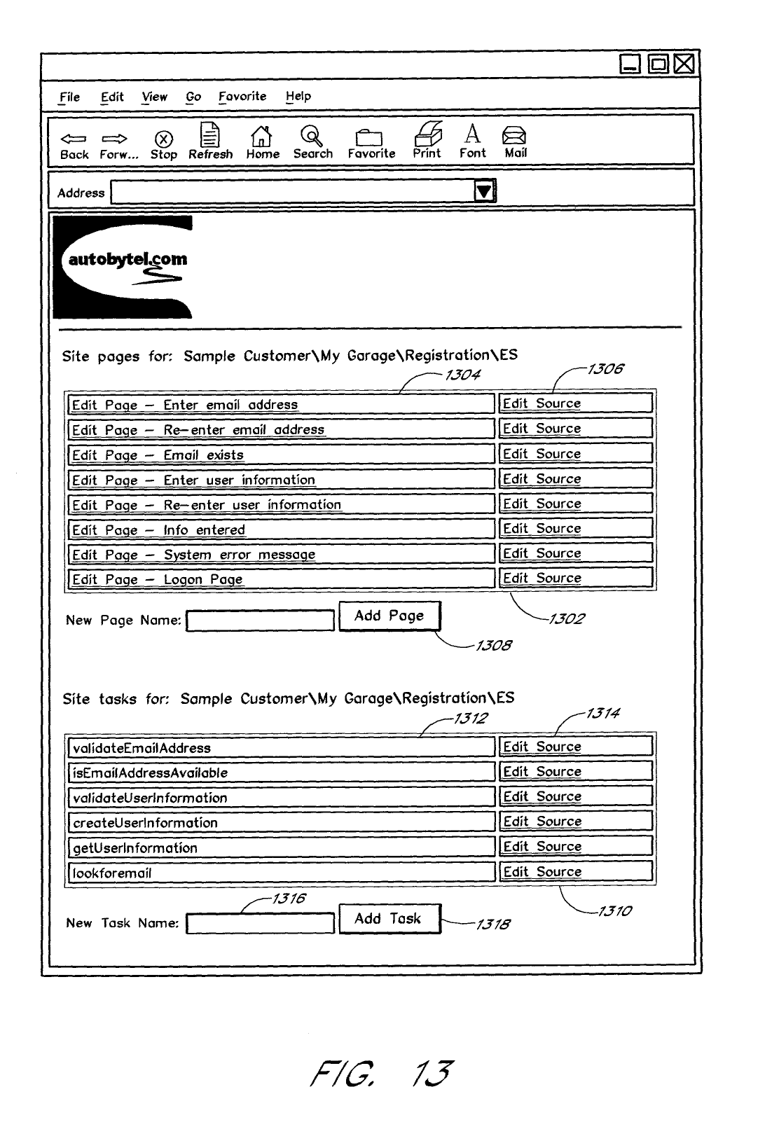

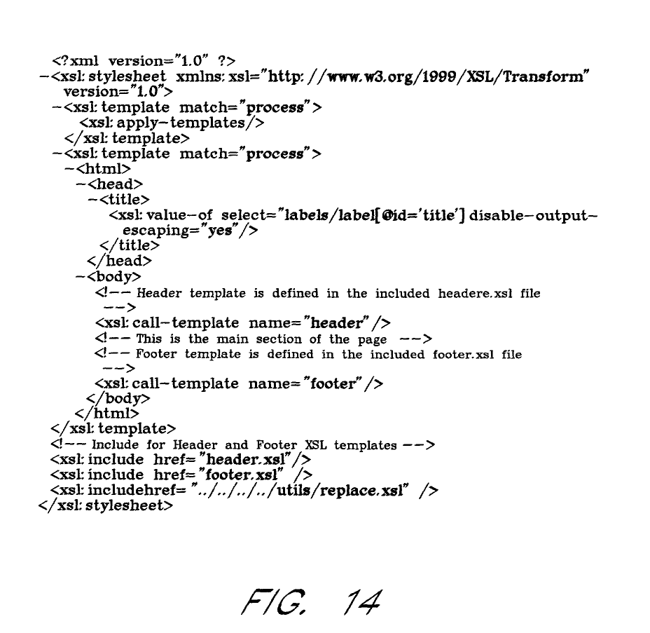

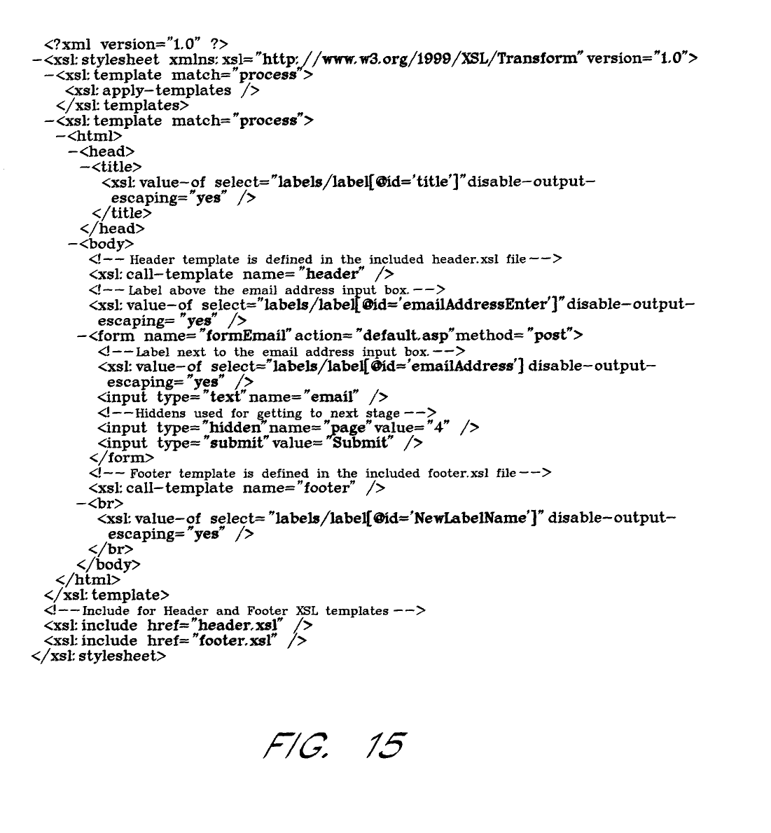

FIG. 14 is a sample default XSL file for a newly created web page. Another sample default XSL file is illustrated in Appendix A. FIG. 15 is a sample XSL file for a web page. An XSL file refers to label identifiers and image identifiers, but not label texts and image file names. Therefore the content of the labels and images are not dependent on the display format defined the XSL file.

Editing Labels on a Page

FIG. 16 is a sample web page for editing a page named “Enter User Information.” For ease of illustration, FIG. 16 is shown as FIG. 16A and FIG. 16B. Referring to FIG. 16A, section 1602 lists all labels for the edited page. For each label, its label id is listed in column 1604, and its label text is listed in column 1606. A user edits a label by changing its label text in column 1606. When label texts have been changed, a user clicks the “Update Labels” button 1608 to order an update of the label definitions. The web editing tool then updates the label definitions in the label definition file to reflect the changed label texts. Since the label identifiers are not changed, the XSL file for the web page does not need to be changed.

In one embodiment, a “Translate Label Text” button (not shown) is associated with each label listed in section 1602. The user clicks the button and selects a language to translate the label text into. For example, when the user selects “Spanish”, then the current English label text is automatically sent to a translating application and returned as a Spanish label text. The user can then modify the returned Spanish label text in column 1606. Another button “Translate All Labels” (not shown) can also be activated to automatically translate all listed labels in section 1602 to another language. If the user is not satisfied with the automatically translated label text, the user can manually modify the translated label text in column 1606.

In one embodiment, a “Remove Label” button (not shown) is associated with each label listed in section 1602. After the “Remove Label” button is activated, the web editing tool removes the associated label from the .XSL file of the edited page. The label definition in the label definition file is advantageously not removed, so that the label definition can be reused by other pages.

Still referring to FIG. 16A, section 1610 allows a user to add already defined labels to the edited page, or to define new labels and add the newly defined labels to the edited page. A user creates a new label definition by entering a label identifier in column 1612 and entering a label text in column 1614. A user can also add an already defined label to the edited page by selecting a label from a scroll down list of labels. The scroll down list is placed in column 1612 or column 1614. In one embodiment, the web editing tool retrieves the scroll down list of labels from the label definition file, which includes all labels for the sub-site. In one embodiment, the web editing tool does not include in the scroll down list the labels already displayed on the edited page. In another embodiment, the web editing tool does not allow the user to select from the scroll down list the labels already displayed on the edited page. After the user completes entering the new label identifier and new label text, or after the user completes selecting a defined label, the user clicks the “Add Label” button 1616. The web editing tool then adds the label identifier of the new label to the XSL file for the edited page, for example as the last element of the body tag in the XSL file. If the newly added label has not been defined in the label definition file, the web editing tool also adds the newly added label to the label definition file of the sub-site.

Editing Tasks on a Page

Referring to section 16B, column 1620 lists tasks of the edited page. The tasks “isEmailAddressAvailable” and “validateEmailAddress” are shown in column 1620 of FIG. 16B. Each listed task includes a success task or page field 1622 and a fail task or page field 1624. The success task or page field represents the task to be invoked or the page to be displayed when the listed task is successfully executed. The fail task or page field represents the task to be invoked or the page to be displayed when the listed task is unsuccessfully executed. A fail task or page field typically represents a page that displays an error message or a task that allows the user to retry. Each listed task also includes a “Remove Task” button 1626.

For a success task or page field 1622 or a fail task or page field 1624, a user can select an existing task or page from a scroll down list of tasks and pages. After a user selects a task or page from a scroll down list and clicks the “Update Tasks” button 1628, the web editing tool finds the page whose page header 610 corresponds to the edited page in the master XML file, and updates the “success” field and/or “fail” field of the edited page in the build node 612 of the master XML file with the newly selected task or page.

In one embodiment, the scroll down list of tasks and pages includes the tasks and pages at the current country level. In another embodiment, the scroll down list of tasks and pages includes more tasks and pages, such as all the tasks and pages of the program level, all tasks and pages of the product level, or all tasks and pages of the web site. In yet another embodiment, the user selects a success task or page from a scroll down list of success tasks and pages, and selects a fail task or page from a scroll down list of fail tasks and pages. A scroll down list of success tasks and pages is a collection of tasks and pages that may be invoked or displayed following the successful execution of a task. A scroll down list of fail tasks and pages is a collection of tasks and pages that may be invoked or displayed following the unsuccessful execution of a task.

A “Remove Task” button 1626 is associated with every listed task of the edited page. When a user clicks the “Remove Task” button 16260, the associated task is removed from the master XML file build node 612 that corresponds to the edited page. Advantageously, the task is not removed from the task list section 606 of the mater XML file, nor is the task removed from the task definition files, so that the task can be used by other web pages.

Still referring to FIG. 16B, section 1630 allows a user to add a task to the edited page “Enter user information.” A user selects a task to be added to the edited page from a scroll down list of tasks in field 1632. In one embodiment, the scroll down list of tasks includes all tasks within the sub-site, and is retrieved by the web editing tool from the task list section 606 of the master XML file. In another embodiment, the scroll down list of tasks includes more tasks, such as all tasks of program level, all tasks of the product level, or all tasks of the web site. For the new task to be added to the edited page, the user also selects a success task or page from a scroll down list of success tasks and pages in field 1634. The user also selects a fail task or page from a scroll down list of fail tasks and pages in field 1636. In one embodiment, the scroll down list of success tasks and pages and the scroll down list of fail tasks and pages include all tasks and pages within the country level. In another embodiment, the two scroll down lists of tasks and pages includes more tasks and pages, such as all task and pages of the program level, all tasks and pages of the product level, or all the tasks and pages of the web site.

After a task and its corresponding success task or page and fail task or page are selected, a user clicks the “Add Task” button 1638 to add the task to the edited page “Enter User Information.” The newly added task is added by the web editing tool to the task list section 606 of the master XML file. The task is also added to the build node section 612 of the master XML file for the edited page. For example, as shown in section 1630, the newly added task has task id 3 and task name “ValidateEmailAddress,” page “Enter email address” with page id 4 is selected as the successful task or page, page “Error Page” with page id 3 is selected as the fail task or page. After the user clicks the “Add Task” button 1638, the web editing tools add the following line to the build node section 612 of the “Enter User Information” page in the page section 608 of the master XML file:

<task id=“3” success=“page 4” fail=“page 3” />

Editing Images on a Page

Still referring to FIG. 16B, column 1640 lists image identifiers of the images that are displayed on the edited page. Column 1642 lists image file names of the images that are displayed on the edited page. A user updates an image by updating the image file name in column 1642. A user then clicks the “Update Images” button 1644 to order the image file names to be updated. The web editing tool then updates the image file names in the image definition file.

A user can also add a new image definition by entering a new image identifier in column 1650 and entering a image file name in column 1652. After the user clicks the “Add Image” button 1654, the newly created image definition is added to the image definition file for the sub-site. The newly created image identifier is also added to the XSL file for the edited web page. In another embodiment, an imaged already defined in the image definition file for the sub-site is selected to be added to the edited page. The user selects the image from a scroll down list of images in column 1650 or column 1652. After the user clicks the “Add Image” button 1654, the image identifier of the selected image is added to the XSL file for the edited web page.

Editing Labels, Images and Tasks WYSWYG Style

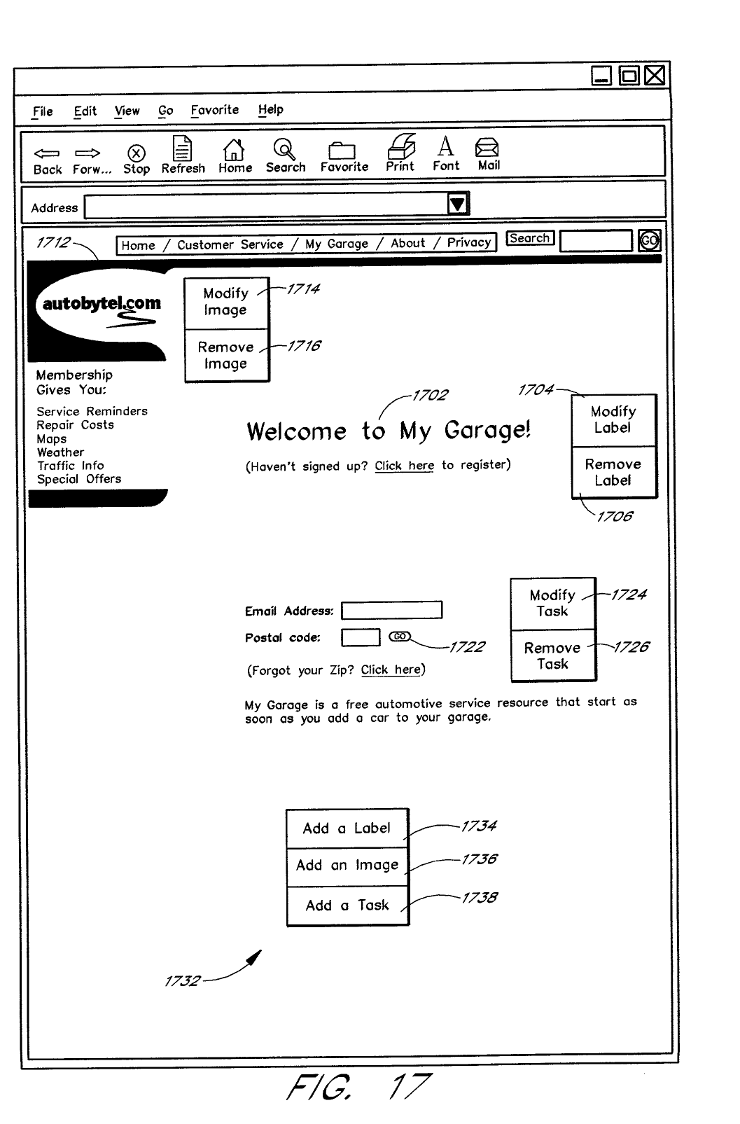

FIG. 17 is a sample web page for editing labels, images, and tasks on a page level, in a WYSWYG (What You See is What You Get) style. In one embodiment, each label, image and task on the web page is identified by a symbol, such as a double underline. In another embodiment, a label, image, or task is identified when a user moves a cursor over the label, image, or task and an option box is displayed on the web page next to the cursor.

For example, when a cursor is moved over the label “Welcome to My Garage!” at section 1702, or when a user right-clicks on the label at section 1702, an option box is displayed on the web page. The option box includes the option “Modify Label” in section 1704 and the option “Remove Label” in section 1706. Another option box with the options “Modify Image” at section 1714 and “Remove Image” at section 1716 can be displayed for the image at section 1712. Yet another option box with the options “Modify Task” at section 1724 and “Remove Task” at section 1726 can be displayed for the task “ValidateEmailAddress” at section 1722. The details of modifying and removing labels, images, and tasks from a web page have been described above in connection with FIG. 16. After an image, label, or task is modified or removed, the currently displaying web page is refreshed to reflect the change.

To add a label, image, or task to the currently displaying web page, a user selects an empty location such as section 1732 on the web page and right clicks an option “Add a label” at section 1734, “Add an image” at section 1736, or “Add a task” at section 1738. The details of adding a label, an image, or a task have been described above in connection with FIG. 16. The XSL file of the web page is automatically modified to include the added image identifier or label identifier at the selected location 1732. The master XML file is automatically modified to include the added task. The label or image is inserted at the selected location. The web page is refreshed to display the new label, image, or task.

One embodiment of the invention has been described in connection with localizing A U.S. web site in international markets. It should be recognized that the invention can be applied to other web site editing purposes, such as editing a web site that changes over time, editing a web site that changes according to new product releases, and so forth. The invention is defined by the following claims and their equivalents.

What is claimed is:

1. A system for editing a web site having a plurality of web pages, said system comprising:
a task editing module configured for creating, modifying and removing a plurality of tasks that may be invoked by said web site, each of said plurality of tasks comprising a task identifier and a task function, said plurality of tasks being stored in one or more task definition files;
a label editing module configured for creating, modifying and removing a plurality of labels that may be displayed on one or more of said plurality of web pages of said web site, each of said plurality of labels comprising a label identifier and a label text, said plurality of labels being stored in one or more label definition files;
an image editing module configured for creating, modifying and removing a plurality of images that may be displayed on one or more of said plurality of web pages of said web site, each of said plurality of images comprising an image identifier and an image file name, said plurality of images being stored in one or more image definition files; and
a page generating module configured for generating each of said plurality of web pages of said web site, said page generating module being configured to obtain a display format of a web page from a style sheet file, said style sheet file including label identifiers of the labels to be displayed on said web page and image identifiers of the images to be displayed on said web page, said page generating module being further configured to obtain from label definition files the label texts of the labels to be displayed on said page, said page generating module being further configured to obtain from image definition files the image file names of the images to be displayed on said page, said page generating module being further configured to obtain from task definition files the task functions of the tasks to be invoked on said page.

2. The system of claim 1, wherein said web site comprises a root level, a page level and an intermediate level, wherein said web site is divided at said intermediate level into multiple sub-sites, each of said sub-sites comprising one or more of said plurality of web pages.

3. The system of claim 2, wherein said task editing module is configured to divide said plurality of tasks into multiple task groups such that each of said multiple task groups corresponds to each of said multiple sub-sites, each of said task groups includes one or more of said plurality of tasks that may be invoked by the corresponding sub-site.

4. The system of claim 3, wherein said task editing module is configured to modify a task of a sub-site by modifying said task on a web page of said sub-site.

5. The system of claim 2, wherein said label editing module is configured to divide said plurality of labels into multiple label groups such that each of said multiple label groups corresponds to each of said multiple sub-sites, each of said label groups includes one or more of said plurality of labels that may be displayed by the corresponding sub-site.

6. The system of claim 5, wherein said label editing module is configured to modify a label of a sub-site by modifying said label on a web page of said sub-site.

7. The system of claim 2, wherein said image editing module is configured to divide said plurality of images into multiple image groups such that each of said multiple image groups corresponds to each of said multiple sub-sites, each of said image groups includes one or more of said plurality of images that may be displayed by the corresponding sub-site.

8. The system of claim 7, wherein said image editing module is configured to modify an image of a sub-site by modifying said image on a web page of said sub-site.

9. The system of claim 1, wherein said page generating module generates web pages dynamically upon receiving a generation request from a client.

10. The system of claim 1, wherein said one or more label definition files are XML (eXtensible Markup Language) files.

11. The system of claim 1, wherein said one or more image definition files are XML files.

12. The system of claim 1, wherein said one or more task definition files are Active Server Page files.

13. The system of claim 1, wherein said one or more task definition files are Java Server Page files.

14. The system of claim 1, wherein said one or more task definition files are scripting language files.

15. The system of claim 1, wherein a user interface of said task editing module is programmed in a markup language.

16. The system of claim 1, wherein a user interface of said image editing module is programmed in a markup language.

17. The system of claim 1, wherein a user interface of said label editing module is programmed in a markup language.

18. The system of claim 1, wherein said task editing module is configured to assign a success task or page identifier and a fail task or page identifier to each of said plurality of tasks (said master task), said success task or page identifier identifies a task to be invoked or a web page to be displayed if said master task is successfully executed, said fail task or page identifier identifies a task to be invoked or a web page to be displayed if said master task is unsuccessfully executed, wherein modifying a master task comprises modifying a success task or page identifier or a fail task or page identifier of said master task.

19. A method of modifying a web site having a plurality of web pages, said method comprising:
storing label definitions in one or more label definition files in a markup language format, each of said label definitions comprising a label identifier and a label text;
storing task definitions in one or more task definition files, each of said task definitions comprising a task identifier and a task function;
storing image definitions in one or more image definition files in a markup language format, each of said image definitions comprising an image identifier and an image file name;
for each of said plurality of web pages, identifying one or more (if any) labels to be displayed on said web page by referring to said label identifiers of said labels, identifying one or more (if any) images to be displayed on said web page by referring to said image identifiers of said images, and identifying one or more (if any) tasks to be invoked on said web page by referring to said task identifiers of said tasks;
prompting a user to modify a stored definition of a label, a task, or an image; and
for each of said plurality of web pages, generating said web page upon receiving a generation request, according to said identified labels, images, and tasks.

20. The method of claim 19, wherein said plurality of web pages includes a label editing web page, wherein said prompting a user to modify a stored definition of a label comprises prompting said user to modify a definition of a label on said label editing web page.

21. The method of claim 19, wherein said plurality of web pages includes a task editing web page, wherein said prompting a user to modify a stored definition of a task comprises prompting said user to modify a definition of a task on said task editing web page.

22. The method of claim 19, wherein said plurality of web pages includes an image editing web page, wherein said prompting a user to modify a stored definition of an image comprises prompting said user to modify a definition of an image on said image editing web page.

23. The method of claim 19, wherein said prompting a user to modify a stored definition of a label, a task, or an image comprises prompting a user to modify a definition of a label, a task, or an image on a web page on which said label, task, or image is displayed or invoked, said web page being one of said plurality of web pages.

24. The method of claim 19, wherein generating said web page comprises dynamically generating said web page upon receiving a generation request from a client.

25. The method of claim 19, wherein said web site comprises a plurality of sub-sites, wherein storing label definitions in one or more label definition files comprises storing label definitions in a plurality of label definition files each corresponding to a sub-site.

26. The method of claim 19, wherein said web site comprises a plurality of sub-sites, wherein storing task definitions in one or more task definition files comprises storing task definitions in a plurality of task definition files each corresponding to a sub-site.

27. The method of claim 19, wherein said web site comprises a plurality of sub-sites, wherein storing image definitions in one or more image definition files comprises storing image definitions in a plurality of image definition files each corresponding to a sub-site.

28. The method of claim 19, wherein each task definition of a task (said master task) further comprises a success task or page identifier and a fail task or page identifier, said success task or page identifier being a task identifier of the task to be invoked or a page identifier of the web page to be displayed if said master task is successfully executed, said fail task or page identifier being a task identifier of the task to be invoked or a page identifier of the web page to be displayed if said master task is unsuccessfully executed.

29. The method of claim 19, wherein identifying one or more labels to be displayed on a web page comprises identifying said labels in a style sheet file associated with said web page, wherein identifying one or more images to be displayed on a web page comprises identifying said images in said style sheet file.

30. The method of claim 19, wherein said web site comprises a plurality of sub-sites, the method further comprising creating a markup language file for each of said plurality of sub-sites, said markup language file including a first list of web pages of the sub-site, said markup language file further including, for each of said listed web pages, a second list of tasks that may be invoked on said web page.

31. The method of claim 30, wherein said markup language file is an XML file.

32. The method of claim 30, further comprising:
prompting said user to add a task to one of said plurality of web pages by referring to a task identifier of said task; and
automatically modifying a markup language file of a sub-site of said web page to include said added task in a second list of tasks for said web page.

33. The method of claim 30, further comprising:
prompting said user to remove a task from one of said plurality of web pages by referring to said task identifier of said task; and
automatically modifying a markup language file of a sub-site of said web page to remove said task from a second list of tasks for said web page.

34. The method of claim 19, further comprising:
prompting said user to change a hyperlink.

35. The method of claim 19, further comprising:
Prompting a user to select one of said plurality of web pages for display;
prompting said user to add a label to said displayed web page by prompting said user to enter a label text for a new label definition or to select an existing label definition from the stored label definitions;
automatically storing said new label definition in one of said label definition files, if said user has entered a new label definition; and
automatically updating a style sheet file associated with said displayed web page to include a label identifier to said entered new label definition or to said selected existing label definition.

36. The method of claim 35, further comprising:
prompting said user to identify a location on said displayed web page for displaying said added label; and
automatically updating said style sheet file to associate said identified location with said label identifier to said added label.

37. The method of claim 19, further comprising:
prompting a user to select one of said plurality of web pages for display;
prompting said user to add an image to said displayed web page by prompting said user to enter an image file name for a new image definition or to select an existing image definition from the stored image definitions;
automatically storing said new image definition in one of said image definition files, if said user has entered a new image definition; and
automatically updating a style sheet file associated with said displayed web page to include an image identifier to said entered new image definition or to said selected existing image definition.

38. The method of claim 37, further comprising:
prompting said user to identify a location on said displayed web page for displaying said added image; and
automatically updating said style sheet file to associate said identified location with said image identifier to said added image.
